(19) United States
(12) Patent Application Publication
(10) Pub. No.: US 2013/0191095 A1
(43) Pub. Date: Jul. 25, 2013

(54) SIMULATION OF A GEOLOGICAL PHENOMENON

(71) Applicant: Gérard Massonnat, Pau (FR)

(72) Inventor: Gérard Massonnat, Pau (FR)

(73) Assignee: TOTAL SA, Courbevoie (FR)

(21) Appl. No.: 13/876,426

(22) PCT Filed: Sep. 14, 2011
(86) PCT No.: PCT/FR11/52111

§ 371 Date: Mar. 27, 2013

(30) Foreign Application Priority Data
Sep. 27, 2010 (FR) 10 57751

(51) Int. Cl. G06F 17/50

(52) U.S. Cl. CPC G06F 17/5009
USPC 703/6

(57) ABSTRACT

A method for simulating a geological phenomenon which resulted in the formation of a geological region, comprising the following steps:
(a) defining a model of the geological region,
(b) receiving an observation of a given parameter of the geological region,
(c) defining the relevant zone, for which the observation received in step (b) is relevant,
(d) simulating the geological phenomenon based on the model,
(e) estimating the value of the given parameter for the relevant zone of the model,
(f) comparing the observation of the given parameter received in step (b) with the estimate of said parameter obtained in step (e), and
(g) modifying a simulation parameter based on the results of the comparison in step (f).

### RELATED APPLICATIONS

The present application is a National Phase entry of PCT Application No. PCT/FR2011/052111, filed Sep. 14, 2011, which claims priority from FR Application No. 10 57751 filed Sep. 27, 2010, both of which are hereby incorporated by reference herein in their entirety.

### FIELD OF THE INVENTION

The invention relates to the field of simulating geological phenomenon for the purposes of subsoil analysis.

The geological phenomenon may be a karstification phenomenon or a sedimentation phenomenon.

### BACKGROUND OF THE INVENTION

It is known to model a geological region in a static manner, using geological and seismic observations. When drilling a well, data gathered via the well and referred to as well data can then be used to adjust the model for the region using an inversion approach. This traditional approach is limited, however, as it does not dynamically reproduce the geological and hydrological processes leading to the formation of the geological region, and adjusting the model to the well data can be relatively complex and sometimes unstable.

It is also known to simulate the geological phenomenon or phenomena (forward modeling) leading to the formation of the geological region, based on a model of the region. For example, the article by O. Jaquet et al., “Stochastic discrete model of karstic networks”, Advances in Water Resources 27 (2004), 751-760, describes a method for modeling karstification phenomena based on a stochastic approach.

Typically, qualitative parameters are used to determine the end of the simulation, which can lead to results that are relatively far removed from the geological reality.

### SUMMARY OF THE INVENTION

The invention improves this situation. A first aspect of the invention proposes a method for simulating a geological phenomenon having resulted in the formation of a geological region, comprising the following steps:

a) defining a model of the geological region,

b) receiving an observation of a given parameter of the geological region,

c) defining a zone of the model, herein referred to as the relevant zone, for which the observation received in step b) is relevant,

d) simulating the geological phenomenon in the model of the geological region,

e) estimating the value of the given parameter for the relevant zone of the model, using the results of the simulation,

f) comparing the observation of the given parameter received in step b) with the estimate of this parameter obtained in step e), and

g) modifying a simulation parameter to adjust the effects of the simulation for at least a portion of the model, based on the results of the comparison in step f).

The observation is thus used to control one or more parameters of the simulation.

The manner in which the model of the geological region evolves is therefore a function of the degree of similarity between the observation received in step b) and the estimate obtained in step e).

Steps c) and e), which define a relevant zone and estimate the parameter for this relevant zone, allow such a use of the observation in the context of the modeling method.

Steps d), e), f) can be regularly repeated as long as the observation and estimation of the given parameter are not sufficiently close.

For example, one can simply leave the simulation parameters unchanged as long as the results of the comparisons in step f) show that the observation and the estimation of the given parameter are not sufficiently close, and end the simulation otherwise. The simulation allows the model of the geological region to evolve until this model corresponds to the observation, while avoiding the instability and complexity of inversion methods.

This also avoids ending the simulation on a qualitative basis, which provides a better adjustment to the measurements received and therefore improves the quality of the simulation.

In another example, the effects of the simulation can be amplified or limited depending on the result of the comparison in step f). For example, if the comparison shows that the estimate obtained in step e) is still very different from the observation received in step b), a simulation parameter can be modified to accentuate the effects of the simulation on the model. Steps d) to g) can be regularly repeated, so that as the estimate obtained in step e) approaches the observation received in step b), a simulation parameter is modified to attenuate the effects of the simulation on the model. It can be arranged so that the simulation ends when the simulation parameter reaches a certain predetermined threshold.

The simulation parameter can, for example, comprise a frequency of simulation cycles, a number of simulation cycles, a number of particles to be introduced per cycle, a sedimentation rate, a karstification index, or some other parameter.

In step g), the simulation can be adjusted to affect the entire model, or only a zone of the model. In the latter case, due to its local nature, the adjustment of the effects of the simulation may better correspond to reality in the geological region.

In particular, a representative zone can be defined for an observation, for example the relevant zone, and the adjustment of the simulation in step g) can be done so that it only concerns this representative zone. The representative zone can be different from the relevant zone: for example, the representative zone can comprise the relevant zone.

The observation and the estimation of the given parameter can be considered to be sufficiently close when the difference or the ratio between the observation and the estimation of the given parameter is less than a predetermined threshold. In general, the invention is not limited by the type of test used in the comparison step f).

The invention is also not limited to the order listed above for the steps a) to g). For example, step b) can be carried out prior to step a), or step c) can be carried out at the same time as the simulation step d).

It is possible to make one or more observations, for one or more parameters. To obtain the observation(s), one or more measurements of this) these parameters are made, for example by making use of well facilities.

Advantageously, when several observations are received, steps c), e) and f) are carried out as many times as there are observations. This provides multiple comparison results, meaning more information for choosing how to adjust the effects of the simulation in a more appropriate manner in step g). For example, the simulation is ended only if a certain number of comparisons show a sufficient degree of similarity between the observations and the corresponding estimates.

Advantageously, each observation is associated with a representative zone, and for each representative zone, the simulation parameter corresponding to this zone is modified based on the result of the comparison between the observation corresponding to this zone and the estimate corresponding to this zone. Thus, the simulation is adjusted zone by zone. For example, the simulation is ended in the zones where the adjustment satisfies the comparison, while the process is continued in the other zones where the adjustment is still insufficient. Thus it is locally determined when to adjust the simulation, based on the observations, which provides better adjustment of all the observations.

One can, for example, divide the model into as many portions as there are observations, and for each portion the simulation is ended when the estimated parameter and the corresponding simulated parameter are sufficiently close, independently of the other portions of the model.

Advantageously, at least one supplemental representative zone can be defined for at least one observation. During step g), depending on the results of the comparison in step f), the effects of the simulation on the representative zone and on this at least one supplemental representative zone can be adjusted.

For example, a supplemental simulation parameter is associated with each supplemental representative zone. In step g), the simulation parameter associated with the representation zone and each supplemental simulation parameter may be modified, depending on the results of the comparison in step f).

For example, if the observation and the corresponding estimate are sufficiently close, the simulation is ended for the corresponding representative zone, and for each of the supplemental representative zones around this representative zone, the simulation is continued but the effects of the simulation are attenuated. One can choose to attenuate the effects of the simulation on a zone to a greater or lesser extent depending on the proximity of the zone to the representative zone.

For example, three concentric zones are associated with one observation. When the estimate obtained in step e) is sufficiently close to the observation, the simulation is ended for the central zone, the simulation is continued for the peripheral zone while reducing a sedimentation rate parameter by 25%, and the simulation is continued for the intermediate zone while reducing this sedimentation rate parameter by 50%.

The effects of the simulation are thus attenuated or accentuated to a greater or lesser extent depending on the zones, which has a smoothing effect. This avoids images in which the representative zones have a contrasting appearance.

The values of the simulation parameters associated with the representative zones can be arranged to assume several values which depend on the result of the comparison in step f). Thus, as the estimated parameter draws closer to the observed parameter, the effects of the simulation are attenuated dynamically.

Of course, the invention is in no way limited by this smoothing effect.

Advantageously, a step of scaling the current results of the simulation is performed during the estimation in step e). For example, a tool such as a pressure solver can be used to perform a relevant averaging of parameters such as permeability or some other parameter.

The invention is in no way limited by this scaling step, particularly if, for example, the relevant zone is of the same order of magnitude as a cell in the geological model.

The model of the geological region can comprise a grid network.

During the simulation step, stochastic displacements in the grid, of particles corresponding to water for example, can be simulated. This type of simulation can be applied to the simulation of karstification phenomena.

The invention is in no way limited to such a lattice gas approach, nor to applications for simulating karstification phenomena. For example, sedimentation phenomena can be simulated. One or more geological phenomena can be simulated.

In another aspect, an object of the invention is a computer program product for simulating geological phenomena which led to the formation of a geological region, said computer program being intended to be stored in the memory of a computing device and) or stored on a storage medium which cooperates with a reader of said computing device and) or downloaded via a telecommunication network, wherein said computer program comprises instructions for executing the steps of the method described above.

In yet another aspect, an object of the invention is a simulation device for simulating at least one geological phenomenon which resulted in the formation of a geological region. This device comprises a receiving means for receiving an observation of a given parameter of the geological region. A processing means allows defining a model of the geological region and defining a zone of the model, referred to as the relevant zone, for which the observation received by the receiving means is relevant. The processing means additionally comprises a simulation means for simulating the geological phenomenon based on the model of the geological region. The processing means also allows estimating the value of the given parameter for the relevant zone of the model, using the results of the simulation. The device additionally comprises a comparison means for comparing the observation of the given parameter received from the receiving means with the estimate of this parameter obtained by the processing means. The processing means modifies a simulation parameter to adjust the effects of the simulation for at least a portion of the model, based on the value of a signal received from the comparison means.

The simulation device can comprise, for example, a computer, a central processing unit, a processor, a control unit dedicated to the simulation of geological phenomena, or some other device.

### BRIEF DESCRIPTION OF THE FIGURES

FIG. 1 shows an example of a karstic zone.

FIG. 2 is a flowchart of an example of a simulation method according to one embodiment of the invention.

FIG. 3 shows an example of an image likely to be obtained by a method according to an embodiment of the invention.

FIG. 4 is a flowchart of an example of a simulation method according to another embodiment of the invention.

FIG. 5 shows an example of a geological model segmented into different zones to illustrate the embodiment in FIG. 4.

FIG. 6 shows an example of a simulation device according to one embodiment of the invention.

### DETAILED DESCRIPTION OF EMBODIMENTS

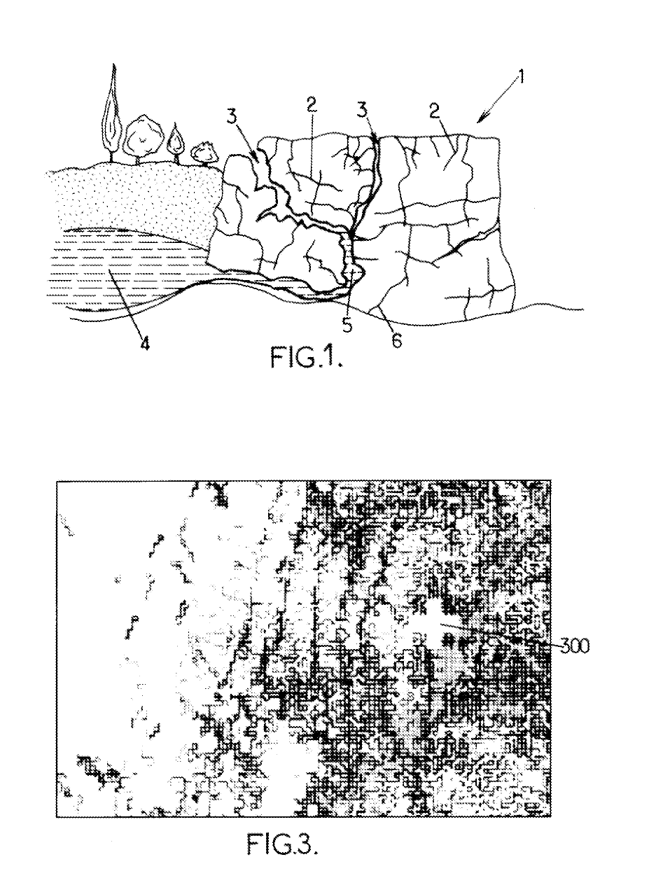

FIG. 1 shows an example of a karstic zone 1. This zone 1 comprises fractures 2, 6 and cavities 3, 5 in a rock. As zone 1 is partially under water, for example due to the proximity of the water table 4, the fractures 6 and cavities 5 may be filled with water.

The rock can, for example, comprise limestone.

Rainwater, or water from the water table or from hydrothermal upwellings, can infiltrate through interstices such as pores in the rock, fractures 2, 6, and) or cavities 3, 5. This infiltration increases the size of these interstices due to dissolution of carbonates in the rock into the infiltrated water, which can lead to the formation of cavities.

In the embodiments represented, this karstification phenomenon is simulated by a lattice gas approach. A gridded geological model of the geological region is defined. Particles representing drops of water, water molecules, or some other particle are introduced into the grid. The stochastic displacement of these particles is simulated and the model evolves based on the displacement of these particles. Here it is assumed that the particles do not interact with each other.

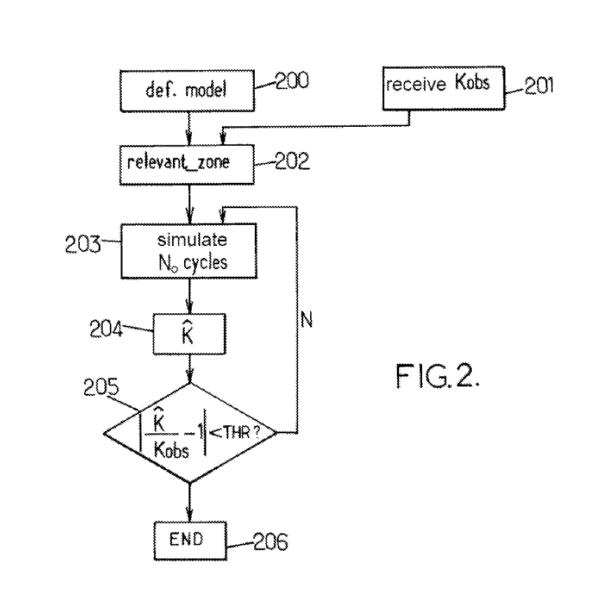

FIG. 2 is a flowchart of an example method according to one embodiment of the invention.

A model of an existing geological region is defined during a step 200. A grid representing the geological region can be defined. The gridded geological model can be two-dimensional, or, advantageously, three-dimensional. The grid model is not limited to sugar-box type grids. More complex mesh geometries can be allowed, for example.

The definition of the model, although represented as a single step 200, can result in setting a certain number of parameters.

For example, during this step 200, the dimensions associated with each grid cell can be defined, for example 100×100×5 meters, as well as certain cell properties such as the facies of the rock corresponding to each cell, porosity, permeability, or other properties.

It is possible to use information obtained from the existing geological region, for example from core plugs or imaging data, providing information on the actual karstic zone, for example the rough locations of geological layers, faults, fractures, impermeable barriers, or other information.

A resealing can also be done during step 200 to decrease the number of cells, for example by a factor of 5³=125 or 10³=1000, in order to limit the simulation time.

During the step 200, discontinuities such as fractures can also be randomly introduced, by using, for example, a Boolean engine. Such an engine can be capable of taking into account the facies of the rock, and of generating several fracture families, with these families being characterized, for example, by fracture densities, fracture geometries, fracture orientations, or other characteristics.

Discontinuities such as bedding or stratification planes can also be introduced.

There may also be steps (not represented) for introducing other discontinuities.

An initial conduit diameter is assigned to the edges of the cell corresponding to these discontinuities, during a step not represented. It is possible for the other edges to have a zero diameter.

During this step 200, different karstification phases can also be defined. For example, a phase can correspond to a period during which the rock remained above water with a certain hydraulic gradient, then another later phase with another period characterized by another hydraulic gradient, etc. To each phase there is a corresponding set of discontinuities among the discontinuities already defined.

For example, there can be defined discontinuities having a north-south orientation and defined discontinuities having an east-west orientation. For example, a first phase can correspond to half of the discontinuities having a north-south orientation and no discontinuities having an east-west orientation, while a second phase corresponds to all the discontinuities.

In addition, for each phase one can define a water corrosivity index IA indicating the water's capacity to dissolve carbonates, a hydraulic gradient, a water saturated zone level, the infiltration zones and saturated zones, a rock orientation, a number of cycles assigned to this phase, a number of particles introduced in each cycle, particle introduction nodes, or other.

Also, observations for a given parameter in the geological region are received during a step 201. In this example, the observed parameter is a permeability parameter K_{obs}, but other parameters can be used such as porosity or other parameters.

During a step 202, a zone of the geological model for which the observation K_{obs} is relevant is defined. For example, a sub-region of the geological region for which this observation K_{obs} is relevant is estimated. For example, if the observation is made in a well, one can assume that for a given volume around this well, the permeability is sufficiently close to K_{obs} for the sub-region to consist of this volume. The volume can be, for example, a cylinder centered around the well and of a given radius, for example 300 meters. The dimensions of the volume can be set by a person skilled in the art. The zone of the model corresponding to this sub-region is determined.

During a step 203, the stochastic displacements of particles in the grid defined in step 200 is simulated.

In this example, a simulation is run for a number of arbitrarily chosen cycles N₀, for example 1000 cycles. In each cycle and for each particle, displacement probabilities for the particle are calculated from the conduit diameter values for the edge of the cell corresponding to this displacement. Then a randomization is performed, taking into account the calculated probabilities, and a displacement is chosen as a function of the result of the randomization. It can be arranged so that each displacement is able to combine an advective displacement and a dispersive displacement.

For example, a method can be used such as the one described in the article by O. Jaquet et al. cited above. Each displacement represents the passage of a particle, and affects the model. For example, a cell permeability value in the grid, and) or a conduit diameter value in the discontinuities, are modified by the passage of the particle. To calculate the modifications, one can take into account a product IK×IA for example, where IK is a karstification index indicative of the dissolution potential of the rock, and IA is a corrosivity index for the particle indicative of the water's capacity to dissolve carbonates.

After N₀ cycles, upscaling is performed in order to estimate an equivalent permeability value \hat{K} in the relevant zone.

Tools such as a pressure solver can be used, for example, based on solving Darcy's equation for the relevant zone.

The values \hat{K} and K_{obs} are compared to each other during a test step 205. A person skilled in the art sets an appropriate threshold value THR, possibly by proceeding in an empirical manner.

The simulation is continued as long as these values are relatively far apart from each other. Optionally there can be a test step (not represented) which would allow ending the simulation when the total number of simulated cycles reaches a maximum limit, to ensure an exit from the loop.

The simulation is ended when the values \hat{K} and K_{obs} are sufficiently close to each other. One can then perform a rescaling (step not represented).

With such a calibration, the model evolves until it is adjusted relative to the observation K_{obs}. The observation of actual data is used for judiciously choosing when to end the simulation.

FIG. 3 shows an example of an image likely to be obtained by a method according to one embodiment of the invention.

In this embodiment, if the comparison between the observed parameter and the estimated parameter shows that these values are sufficiently close, the simulation is ended only for the defined relevant zone, which in this example is the t-shaped zone 300.

The lines in the image represent conduits having a diameter exceeding a threshold. As the simulation progresses, the particles move within the grid and these movements increase the diameter of the conduits followed. Thus the number of conduits having a diameter greater than the threshold increases with the number of cycles simulated.

In this example, the simulation was ended relatively early in the zone 300, so that no lines appear in this zone.

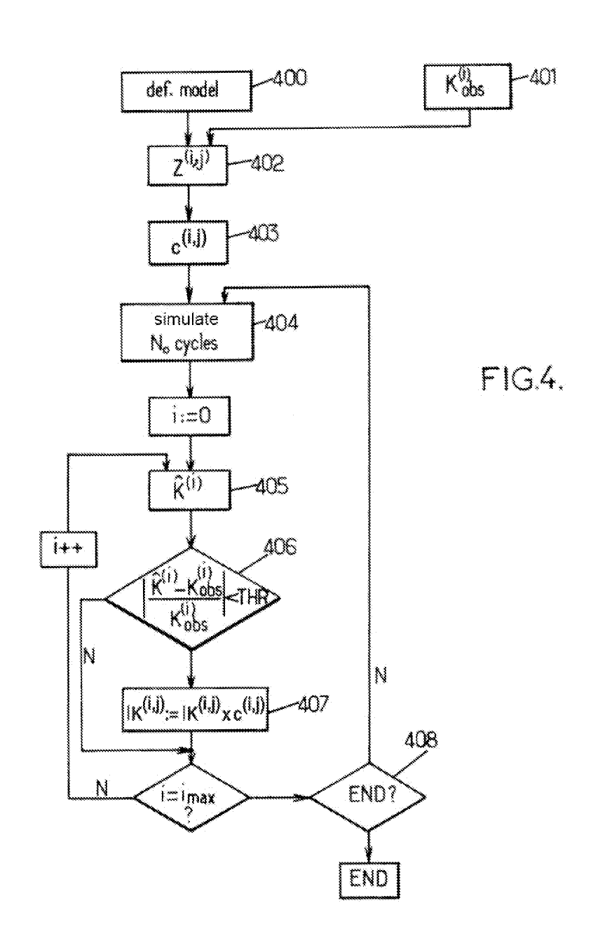

FIGS. 4 and 5 concern an embodiment which attempts to avoid such contrasts between the relevant zone and the rest of the model.

The method in FIG. 4 comprises a step of defining the model 400, and a step 401 of receiving, for example, three observations K_{obs}⁽ⁱ⁾. These observations may, for example, be obtained from well tests.

For each permeability observation K_{obs}⁽ⁱ⁾, in the step 402 a representative zone Z^{(i,1)}, or relevant zone, is defined for which the observation K_{obs}⁽ⁱ⁾ is relevant. A supplemental representative zone Z^{(i,2)}, or zone of influence, is also defined.

Example zones Z^{(i,1)} and Z^{(i,2)} are shown in FIG. 5. In this example, the observations are measured at the wells represented in the model by the labels W₁, W₂, W₃. The relevant zones Z^{(i,1)} correspond to the cells within a certain radius around the modeling for the wells. This radius can correspond to a distance of 300 meters for example. The limits of the zones of influence Z^{(i,2)} can, for example, be chosen arbitrarily, so that the set of defined zones covers the entire model. In this example, a possible overlap of the zones of influence Z^{(i,2)} is observed.

Returning to FIG. 4, during a step 403 each representative zone Z^{(i,j)} is associated with a simulation parameter value, for example a coefficient c^{(i,j)} for weighting the karstification index IK values corresponding to this zone.

There can be one karstification index value IK per zone, or more than one. For example, there can be one karstification index value IK per cell.

For example, for the relevant zones Z^{(i,1)}, c^{(i,1)}=0, and for the zones of influence, c^{(i,2)}=0.5.

Then N₀ simulation cycles are performed during a step 404, with karstification indexes initially not weighted by the coefficients c^{(i,j)}. During a step 405, for each well an equivalent permeability value \hat{K}⁽ⁱ⁾ for the relevant zone Z^{(i,1)} corresponding to this well is estimated, for example by upscaling.

A comparison with the corresponding observed value K_{obs}⁽ⁱ⁾ is performed during a step 406. If the comparison shows that the values K_{obs}⁽ⁱ⁾ and \hat{K}⁽ⁱ⁾ are relatively far apart from each other, then the karstification index values IK^{(i,1)}, IK^{(i,2)} corresponding to the zones Z^{(i,1)} and Z^{(i,2)} remain unweighted.

However, if the comparison shows that the values K_{obs}⁽ⁱ⁾, and \hat{K}⁽ⁱ⁾ are sufficiently close to each other, a step 407 is executed during which:
the karstification index value or values IK^{(i,1)} corresponding to the relevant zone Z^{(i,1)} is/are are weighted by the coefficient c^{(i,1)}=0. Thus the simulation no longer produces an effect for the relevant zone Z^{(i,1)}. The simulation can be ended for the relevant zone Z^{(i,1)}.
the karstification index value or values IK^{(i,2)} corresponding to the zone of influence Z^{(i,2)} is/are weighted by the coefficient c^{(i,2)}=0.5. In other words, the simulation for the zone of influence Z^{(i,2)} can continue, but at half the effectiveness.

Thus, to attenuate the effects of the simulation, the indexes IK and therefore the products IK×IA are weighted, to limit the consequences of particle displacements on the model parameters, for example the conduit diameters. The simulation is considered to end when the particle displacements have zero effect on the parameters of the model such as the conduit diameter or permeability.

The steps 405, 406 and 407 are performed for each of the observations K_{obs}⁽ⁱ⁾. A loop through these three observations can be established, with the conventional steps of initializing, testing, and incrementing.

Thus if the test 406 is positive for several observations, the portions Z^{(i,2)}∩Z^{(i′,2)} of the model corresponding to the overlaps between several zones of influence see their average number of particles to be introduced per cycle and per surface cell weighted by both c^{(i,2)} and c^{(i′,2)}.

Once the steps 405, 406 and 407 are performed for each of the observations K_{obs}⁽ⁱ⁾, a step 408 verifies that an observation exists for which the test 406 was negative. If so, the simulation resumes, with, for each observation for which the test 406 was positive, zones for which the simulation is stopped, or attenuated in its effect, or without effect.

If the test 408 shows that the test 406 is positive for all observations, then the simulation is ended.

In one embodiment variant, the weighting coefficients c^{(i,j)} weight not the karstification index, but a number of particles to be introduced into the network per cycle and per surface cell of the model. In this variant, it can be arranged so that any particles present in the model are eliminated before each set of N₀ simulation cycles.

In another embodiment variant, the weighting coefficients c^{(i,j)} modulate the number of cycles N₀ to be carried out for a portion of the given model. In this manner, one can have a normal simulation for a portion of the model, and no displacement every other cycle for example for a zone of influence.

Alternatively, the simulation parameter can comprise a number of cycles to be executed before the next comparison between estimated values and measured values.

The invention is in no way limited by the manner in which the effects of the simulation are adjusted.

In another embodiment variant, the observations can comprise measurements made in wells at variable depths. For each well, and for each observation corresponding to a given depth interval, a relevant zone is defined. For example, cylindrical relevant zones can be defined along the well at various depths. For each relevant zone, the observed parameter is estimated based on the simulated model. If this observed parameter is sufficiently close to the estimated parameter, the simulation is ended for the relevant zone.

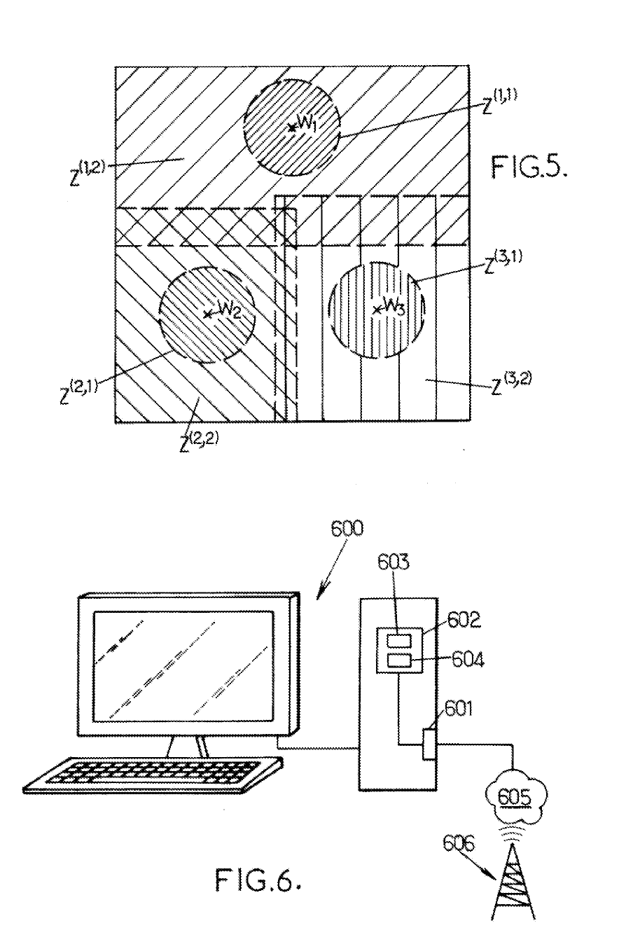

An example of a simulation device 600 is represented in FIG. 6. In this embodiment, the device comprises a computer 600, comprising a receiving means 601 for receiving an observation of a given parameter of the geological region, for example a modem 601 connected to a network 605 which is itself in communication with a well 606. The device 600 additionally comprises memory (not represented) for storing the gridded geological model. A processing means, for example a processor 602, comprises a comparison means 603 for executing the step 205 in FIG. 2, and a simulation means 604 for simulating stochastic displacements of particles in the model stored in the memory. The processing means 602 is, for example, able to execute the steps 200, 202, 204 and 206 of FIG. 2.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1-10. (canceled)

11. A method for simulating a geological phenomenon which resulted in the formation of a geological region, comprising the following steps:
a) defining a model of the geological region,
b) receiving an observation of a given parameter of the geological region,
c) defining a zone of the model for which the observation received in step b) is relevant,
d) simulating the geological phenomenon based on the model of the geological region defined in step a),
e) estimating the value of the given parameter for the relevant zone of the model defined in step c), using the results of the simulation,
f) comparing the observation of the given parameter received in step b) with the estimate of said parameter obtained in step e), and
g) modifying a simulation parameter to adjust the effects of the simulation for at least a portion of the model, based on the results of the comparison in step f).

12. The simulation method according to claim 11, wherein, in step g), the simulation is ended if the results of the comparison in step f) show that the observation and the estimate for the given parameter are sufficiently close.

13. The simulation method according to claim 11, wherein, in step g), the simulation parameter is modified in a manner that attenuates the effects of the simulation on said at least a portion of the model.

14. The simulation method according to claim 11, wherein,
in step b), multiple observations are received, the steps c), e) and f) being performed for each of the observations received.

15. The simulation method according to claim 14, wherein for each observation, a representative zone for the observation is defined, and
in step g), for each representative zone, the simulation parameter corresponding to said zone is modified based on the result of the comparison between the observation corresponding to this zone and the estimate corresponding to this zone.

16. The simulation method according to claim 15, wherein, for at least one observation,
at least one supplemental representative zone is defined,
each of said supplemental representative zones being associated with a supplemental simulation parameter value,
and during step g), and depending on the results of the comparison in step f), at least said supplemental simulation parameter is additionally modified so as to adjust the effects of the simulation for said at least one supplemental representative zone.

17. The simulation method according to claim 11, wherein
the model for the geological region defined in step a) comprises a grid network, and
during the simulation step d), stochastic displacements of particles in the grid of the geological model are simulated.

18. The simulation method according to claim 11, wherein
the parameter for which an observation is received in step b) is a permeability parameter.

19. A non-transitory computer readable storage medium for simulating a geological phenomenon which resulted in the formation of a geological region, the medium having stored thereon a computer program comprising program instructions, the computer program being loadable into a data-processing unit and adapted to cause the data-processing unit to carry out, when the computer program is run by the data-processing device, the steps of:
a) defining a model of the geological region,
b) receiving an observation of a given parameter of the geological region,
c) defining a zone of the model, herein referred to as the relevant zone, for which the received observation is relevant,
d) simulating the geological phenomenon based on the model of the geological region,
e) estimating the value of the given parameter for the relevant zone of the model, using the results of the simulation,
f) comparing the observation of the given parameter received with the estimate of said parameter, and
g) depending on the results of the comparison, modifying a simulation parameter to adjust the effects of the simulation for at least a portion of the model.

20. A simulation device for simulating a geological phenomenon which resulted in the formation of a geological region, said device comprising
a receiving means for receiving an observation of a given parameter of the geological region,
a processing means for
defining a model of the geological region,
defining a zone of the model, herein referred to as the relevant zone, for which the observation received by the receiving means is relevant,
simulating the geological phenomenon based on the model of the geological region, and
estimating the value of the given parameter for the relevant zone of the model, using the results of the simulation,
a comparison means for comparing the observation of the given parameter received from the receiving means with the estimate of said parameter obtained by the processing means,
and wherein the processing means is arranged to modify a simulation parameter in a manner that adjusts the effects of the simulation for at least a portion of the model after receiving a signal originating from the comparison means.
